(19) United States
(12) Patent Application Publication
(10) Pub. No.: US 2014/0103123 A1
(43) Pub. Date: Apr. 17, 2014

(54) System and Method for Encoding and Using a Digital Camouflage Pattern with a Two-Dimensional Code Linked to an Internet Uniform Resource Locator or Context-Sensitive Coded Message

(71) Applicant: J. Andrew McKinney, JR., Severna Park, MD (US)

(72) Inventor: J. Andrew McKinney, JR., Severna Park, MD (US)

(21) Appl. No.: 14/055,809

(22) Filed: Oct. 16, 2013

Related U.S. Application Data
(60) Provisional application No. 61/714,673, filed on Oct. 16, 2012.
(60) Provisional application No. 61/753,770, filed on Jan. 17, 2013.

(51) Int. Cl. G06K 19/06

(52) U.S. Cl. CPC G06K 19/06037
USPC 235/494

(57) ABSTRACT

A system and method for incorporating manufacturer-selected indicia in a camouflage pattern, used on an item which does not ruin the camouflage's effectiveness, and is programmed to encode a selected indicia such as a manufacturer's brand, an address in a stored Look Up Table or an Internet Uniform Resource Locator used to identify a marked item into a machine readable two-dimensional code pattern such as a QR code pattern having bright portions and dark portions.

### PRIORITY CLAIMS AND REFERENCE TO RELATED APPLICATIONS

This application claims priority to related and commonly owned U.S. provisional patent application No. 61/714,673 filed 16 Oct. 2012 entitled “Digital Camouflage Pattern Incorporating a Two-Dimensional Code linked to an Internet Uniform Resource Locator and Method for Encoding a Digital Camouflage Pattern with a Two-Dimensional Code”, the entire disclosure of which is incorporated herein by reference. This application also claims priority to related and commonly owned U.S. provisional patent application No. 61/753,770, filed 17 Jan. 2013 entitled “Method for Encoding and using a Digital Camouflage Pattern with a Two-Dimensional Code having a Digital Camouflage Pattern Incorporating a Two-Dimensional Code linked to an Internet Uniform Resource Locator or context-sensitive Coded Message”, the entire disclosure of which is also incorporated herein by reference.

### BACKGROUND OF THE INVENTION

1. Field of the Invention

The present invention relates to methods for encoding and using indicia partially or substantially concealed in camouflage patterns on fabric, substrates, apparel, equipment, structures or displays.

2. Discussion of Related Art

Encoded symbols designed for use with automated image sensing equipment such as UPC or EAN bar codes are well known in the manufacturing, warehousing, transportation and retail fields. U.S. Pat. No. 3,145,291 by Brainerd, et al, describes a bar code system for identifying passing rail cars.

More recently, two dimensional codes have been used in specialized manufacturing applications such as the Quick Response or “QR” code system of U.S. Pat. No. 5,408,543 and U.S. Pat. No. 5,410,620 by Yoshida (which correspond to Japanese Pat. 2,742,555). Yoshida's QR code system has a two-dimensional code composed of cells representing discrete pieces of information. Each of Yoshida's QR code cells is binary and assigns “white” to a first logic state of an information piece or “black” to a second logic state of that information piece. An apparatus for reading such a two-dimensional code includes a section for determining whether each cell is white or black. For the code reading system, it is important to decide the position of the center of each cell, and Yoshida's QR code system included the capability of compensating for optical or physical distortions of the data field as viewed by an optical reader, but only if the code were initially imprinted or rendered in the specified manner.

QR codes are now often seen in printed advertisements and marketing materials, because users can encode web site URLs into QR codes and encourage prospective customers to use smart phones to sense or record the encoded URL and then see the content available at the encoded URL's web site.

Entrepreneurs and other business users of advertising or marketing QR codes also want the QR code to be rendered in a manner which is conspicuous and easy for the prospective user to find and use with any smart phone.

Turning to a very different area of endeavor, there are instances where a user may not want something to be visually conspicuous or detectable. Camouflage is often used to provide a surface pattern which disrupts the exposed outline or visible shape of a person or object, so that the camouflaged person or object appears to blend into a background.

The term of art “Crypsis” means blending with the background, making an animal or military equipment hard to see, and is achievable by having a surface which (a) bears a general resemblance to background, (b) has disruptive patterning (breaking up outline), (c) eliminates shadow, (d) provides apparent countershading or provides apparent counter illumination. Some animals' colors and patterns resemble a particular natural background, for example a moth may blend in with tree bark. Disruptive patterns use strongly contrasting markings such as spots or stripes to break up an object's outlines. Some predators (e.g., the Leopard) use disruptive patterns. Disruptive patterns are characterized by high-contrast light and dark patches, in a nonrepetitive configuration, that also provide camouflage by disrupting the recognizable shape or orientation of the animal or object.

The US armed forces have adopted a camouflage pattern with randomly distributed lighter and darker surface segments known as UCP (Universal Camouflage Pattern), ACUPAT (Army Combat Uniform PATtern) or “digital camo” as illustrated in exemplary FIGS. 1 and 2. US army officer Timothy O'Neill suggested that patterns consisting of rectangular square blocks of color would trick the human eye into seeing the UCP pattern as a background. O'Neill's idea was combined with the mixed large and small scale patterns like the German “Flecktarn” into the modern pixelated camouflage patterns like the CADPAT or MARPAT patterns. Battle dress in digital camouflage patterns was first designed by the Canadian Forces. The “digital” refers to the coordinates of the pattern, which are digitally defined, as well as the set of colors used. In this context, “digital” is not limited solely to pixelated patterns of square or rectangular color segments, but to all computer-generated patterns like the non-pixelated “Multicam” and the Italian fractal “Vegetato” pattern.

Digital camouflage (or “camo”) patterns are often used to simplify design and are easier to print on fabric than traditional “analog” camo patterns. Digital, pixilated camouflage patterns such as the “UCP” pattern were adopted by the US military and have been issued to soldiers and others in colors selected for use in woodland, desert and urban environments, where the colors in a given camo pattern are adapted to a given environment. For example, a UCP camo pattern having three shades of tan or brown was selected for desert environments.

Hunters and other sportsmen often wear camouflaged clothing and buy camouflaged equipment and commercial vendors have offered a wide variety of apparel items such as hats, shirts, pants, coats, gloves and footwear, and the vendor often wants to mark the items in a distinctive manner with trademarks or promotional messages. Non-apparel items or equipment are also covered in camouflage patterns. For example, binoculars, firearms, archery equipment, tree stands, tents, and vehicles are often covered in camouflage patterns.

There is a basic problem with many commercial and promotional camouflaged items, however, because if the vendor or manufacturer marks the item with a conspicuous and vivid trademark or logo, that trademark or logo will likely be very conspicuous and thus render the camouflaged item easy to detect, thereby ruining the item for actual hunting use. If the trademark or logo is color matched to the camo pattern, the logo becomes nearly invisible, and the reader is likely to overlook the trademark or logo because it blends with the surrounding camo pattern, thus diminishing the promotional value of the branded item.

Users may also want to identify an item or provide location or context sensitive but concealed information on a surface using hidden or concealed but machine readable indicia, and the conspicuous, traditional black and white QR codes cannot be used in such situations.

There is a need, therefore, for a convenient, flexible, inexpensive and unobtrusive method and system for encoding and using a camouflage pattern with an encoded indicia, possibly incorporating a two-dimensional code linked to an Internet uniform resource locator or context-sensitive coded message which is configured in a camouflage pattern used on an item which does not ruin the camouflage's effectiveness and maintains an adequate level of visual crypsis.

### SUMMARY OF THE INVENTION

Accordingly, it is an object of the present invention to overcome the above mentioned difficulties by providing a convenient, flexible, inexpensive and unobtrusive method and system for encoding and using a camouflage pattern with an encoded indicia, possibly incorporating a two-dimensional code linked to an Internet uniform resource locator or context-sensitive coded message which is configured in a camouflage pattern used on an item which does not ruin the camouflage's effectiveness and maintains an adequate level of visual crypsis. In accordance with the present invention, a composite code-in-camouflage pattern is deemed to maintain an adequate level of visual crypsis when the following conditions are satisfied: (a) the overall effect of the code-in-camouflage pattern retains the original camouflage pattern's property of appearing to break-up a surface (when covered by the composite pattern) into a series of apparently unrelated objects, (b) when the lighter portions of the two-dimensional machine readable code segment substantially blend or match the lighter portions of the camouflage pattern, and (c) when the darker portions of the two-dimensional machine readable code segment substantially blend or match the darker portions of the camouflage pattern. For most applications, the when the lighter portions of the two-dimensional machine readable code segment and the lighter portions of the camouflage pattern will not be white, but will instead be grey, tan, green or a light color found in an ambient environment.

In accordance with the present invention, a digital camouflage pattern incorporating a two-dimensional code such as a Quick Response (“QR”) Code is readily sensed by an transportable image sensor (e.g., as included in many Smart Phones), stored and then used to find an address in a stored Look Up Table or linked to an Internet Uniform Resource Locator (“URL”). The present invention also includes a method for encoding a digital camouflage pattern with a machine readable two-dimensional code such as a QR code.

A manufactured item or object such as an apparel item or a fabric or film substrate is preferably substantially covered with a selected camouflage (or “camo”) pattern surface comprising at least a first array of lighter segments in a first selected color interspersed with a second array of darker segments in a second selected color which are preferably configured to resemble a pixilated digital camo pattern such as the US Army's UCP camo pattern. A selected region of the camouflage pattern surface is imprinted with a contiguous machine readable two-dimensional code pattern such as a QR code pattern having bright portions and dark portions. The QR code pattern's bright portions are substantially the same color as the camo pattern's lighter segments and the QR code pattern's dark portions are substantially the same color as the camo pattern's darker segments.

In an alternative embodiment of the encoded camo pattern of the present invention, a manufactured item or object such as an apparel item or a fabric or film substrate is preferably substantially covered with a selected camouflage (or “camo”) pattern surface comprised entirely of QR code segments having lighter segments in a first selected color interspersed with darker segments in a second selected color and the colors comprise shades of green, brown or blue selected to resemble standard pixilated digital camo pattern such as the US military's UCP camo pattern. The entire surface comprises a plurality of contiguously arrayed machine readable two-dimensional code patterns such as QR code patterns having bright portions and dark portions. The QR code patterns' bright portions provide the camo patterns' lighter segments and the QR code patterns' dark portions provide the patterns' darker segments.

The method of the present invention includes encoding a selected indicia such as a manufacturer's brand, an address in a stored Look Up Table or an Internet Uniform Resource Locator used to identify a marked item into a machine readable two-dimensional code pattern such as a QR code pattern having bright portions and dark portions. The QR code pattern is generated in a selected configuration and orientation with bright portions having a first color and dark portions having a second color. The method of the present invention also includes selecting a specific digital camo pattern having at least a first array of lighter segments in a first selected color interspersed with a second array of darker segments in a second selected color which are preferably configured to resemble a pixilated digital camo pattern such as the US Army's UCP camo pattern. The QR code pattern's bright portion first color is selected to be substantially the same as the camo pattern's lighter segments and the QR code pattern's dark portion second color is selected to be substantially the same as the camo pattern's darker segments. The composite “code in camo” image is then preferably stored as a digital file ready for transmission or imprinted, embossed or painted upon a manufactured item or object such as an apparel item or a fabric or film substrate.

An alternative method of generating the encoded “code-only” pattern of the present invention includes encoding a selected indicia such as a manufacturer's brand, an address in a stored Look Up Table or an Internet Uniform Resource Locator used to identify a marked item into a first machine readable two-dimensional code pattern such as a QR code pattern having bright portions and dark portions. The QR code pattern is generated in a selected configuration and orientation with bright portions having a first color and dark portions having a second color. The method of the present invention also includes selecting a place for the first code pattern within an array of contiguous code patterns having at least a first array of lighter segments in a first selected color interspersed with a second array of darker segments in a second selected color which are preferably configured to resemble a pixilated digital camo pattern such as the US Army's UCP camo pattern. The QR code pattern's bright portion first color is selected to be substantially the same as the camo pattern's lighter segments and the QR code pattern's dark portion second color is selected to be substantially the same as the camo pattern's darker segments and the resulting “code-only” pattern surface is generated in colors comprising shades of green, brown or blue selected to resemble standard pixilated digital camo pattern such as the US Army's green UCP camo pattern. Next, a composite code-only encoded pattern image is generated by inserting the first QR code pattern within an encoded pattern surface area. The composite “code-as-camo” image is then preferably stored as a digital file ready for transmission or imprinted, embossed or painted upon a manufactured item or object such as an apparel item or a fabric or film substrate.

An alternative method of generating the encoded “code-only” pattern of the present invention includes encoded a selected indicia such as but not limited to a rolling encryption key or instructions or directions into a dynamic QR code pattern having bright portions and dark portions. The dynamic QR code pattern remains the same while the underlying encoded information can be updated.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### DESCRIPTION OF THE FIGURES

FIG. 1 illustrates a first exemplary UCP digital camo pattern having a first array of light, rectangular pixels interspersed with a second array of rectangular pixels which are darker than the light pixels and a third array of rectangular pixels which are darkest, in accordance with the prior art.

FIG. 2 illustrates a second exemplary UCP digital camo pattern having a first array of light, rectangular pixels interspersed with a second array of rectangular pixels which are darker than the light pixels and a third array of rectangular pixels which are darkest, in accordance with the prior art.

FIG. 3 illustrates a first encoded indicia configured and aligned within an area with the exemplary UCP digital camo pattern of FIG. 1 having a first array of rectangular light portions interspersed with a second array of dark portions which are darker than the encoded indicia's light portions and darker than the camo pattern area's first array of light pixels such that the composite pattern 400 maintains an adequate level of visual crypsis, in accordance with the present invention.

FIG. 4 illustrates a second encoded indicia configured and aligned within an area with the exemplary UCP digital camo pattern of FIG. 2 and having a first array of rectangular light portions interspersed with a second array of dark portions which are darker than the encoded indicia's light portions and darker than the camo pattern area's first array of light pixels such that the composite pattern 500 maintains an adequate level of visual crypsis, in accordance with the present invention.

FIG. 5 illustrates a “code only” simulated digital camo pattern comprising only encoded indicia configured and aligned within an area which could be covered with a typical UCP digital camo pattern and having a plurality of encoded indicia regions each defining first array of rectangular light portions interspersed with a second array of dark portions which are darker than the encoded indicia's light portions such that the composite pattern 600 maintains an adequate level of visual crypsis, in accordance with the present invention.

FIG. 6 illustrates surface having first and second distinct encoded indicia patterns configured and aligned within an area of an exemplary UCP digital camo pattern, where each coded indicia pattern and has a first array of rectangular light portions interspersed with a second array of dark portions which are darker than the encoded indicia's light portions and darker than the camo pattern area's first array of light pixels such that the composite pattern 800 maintains an adequate level of visual crypsis, in accordance with the present invention.

FIGS. 7A and 7B illustrate the general process of encoding indicia into a QR code and decoding indicia a QR code and the System, in accordance with the present invention.

FIG. 8A illustrates the overall process of generating a QR camo code image having a composite pattern maintains an adequate level of visual crypsis, in accordance with the present invention.

FIG. 8B illustrates the components of a customized QR code, in accordance with the present invention.

FIG. 8C illustrates the components of selected camo pattern, in accordance with the present invention.

FIG. 9 illustrates the shades or colors of the QR code and camo pattern that are used in generating a QR camo code image with a composite pattern maintains an adequate level of visual crypsis, in accordance with the present invention.

FIG. 10 illustrates an embodiment for incorporating manufacturer-selected indicia in a camouflage pattern used on an item which does not ruin the camouflage's effectiveness because the composite pattern maintains an adequate level of visual crypsis, in accordance with the method of the present invention.

FIG. 11 illustrates another embodiment for incorporating manufacturer-selected indicia in a camouflage pattern used on an item which does not ruin the camouflage's effectiveness using a code-only pattern, in accordance with the method of the present invention.

FIG. 12 illustrates using a dynamic QR code over time, in accordance with an alternative embodiment of the method of the present invention.

FIG. 13 illustrates another method for using a dynamic QR code over time, in accordance with an alternative embodiment of the method of the present invention.

### DESCRIPTION OF THE PREFERRED EMBODIMENT

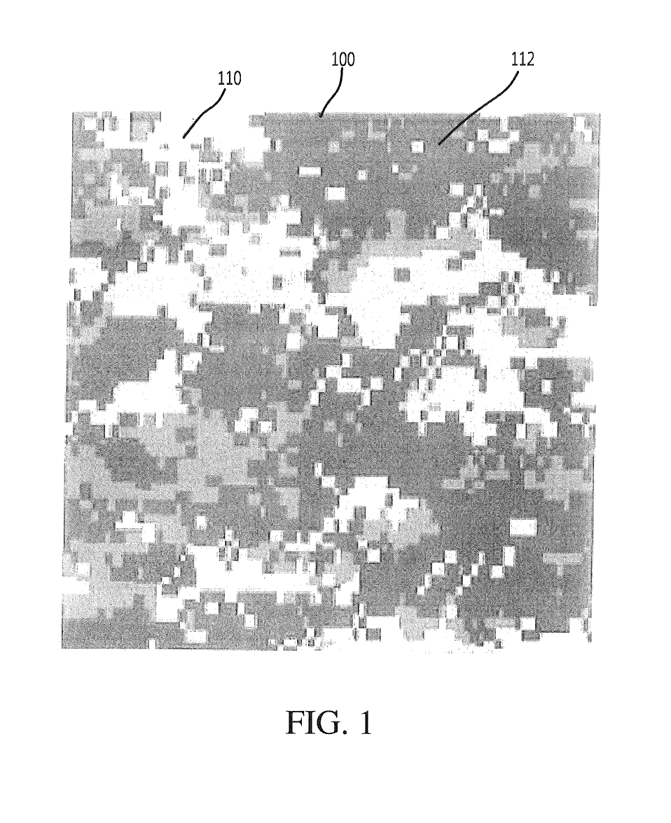

Referring now to FIGS. 1-6, the present invention provides a method and system for encoding one or more selected indicia (e.g., 300), such as an encoded Internet Uniform Resource Locator (“URL”) and discreetly integrating a version of that indicia into a color-matched nearly hidden machine readable two-dimensional code pattern such as a QR code pattern having QR code bright portions and QR code dark portions, to generate a composite pattern (e.g., 400) which maintains an adequate level of visual crypsis.

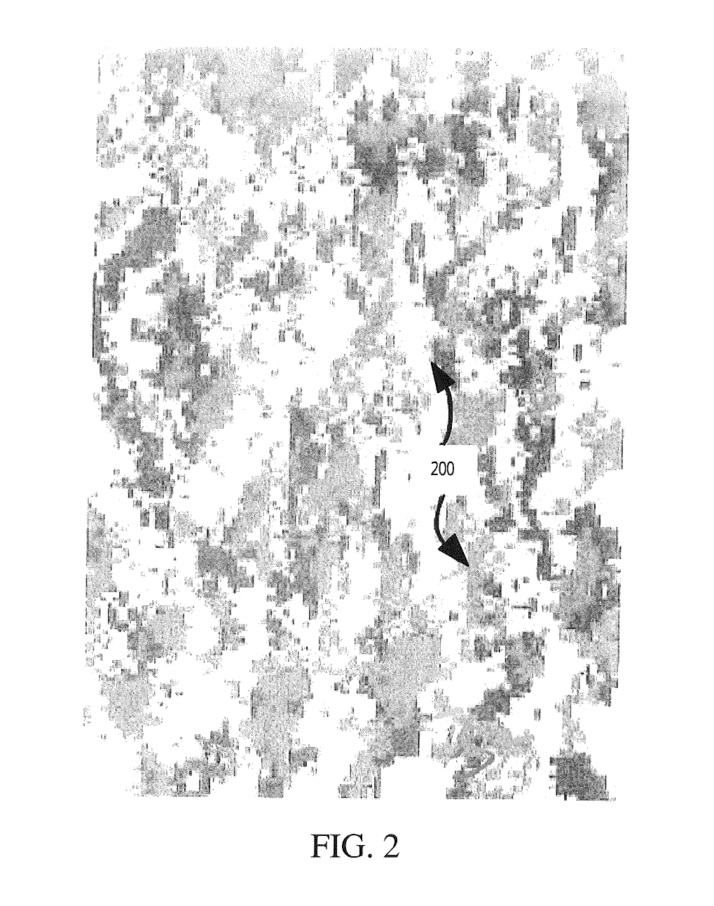

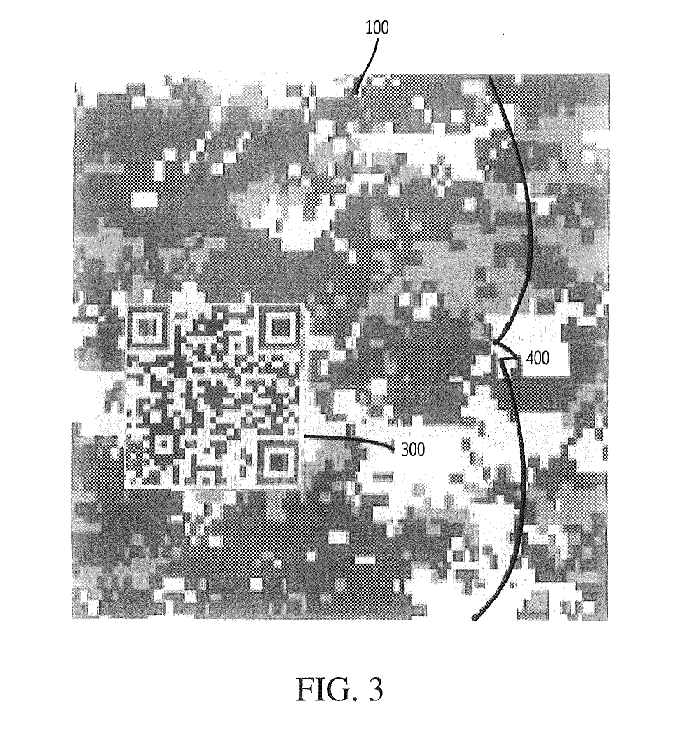

As illustrated in FIGS. 3-5, QR code pattern segment 300 is generated in a selected configuration and orientation with bright portions having a first color (preferably not white) and dark portions having a second color. The method of the present invention also includes selecting a specific digital camo pattern (e.g., 100 or 200) having at least a first array of lighter segments in a first selected color interspersed with a second array of darker segments in a second selected color which are preferably configured to resemble a pixilated digital camo pattern such as the US Military's UCP camo pattern (as illustrated in FIGS. 1 and 2). The QR code pattern's bright portion first color is selected to be substantially the same as the camo pattern's lighter segments and the QR code pattern's dark portion second color is selected to be substantially the same as the camo pattern's darker segments. The composite “code in camo” image (e.g., 400 or 500) is then preferably stored as a digital file ready for transmission or imprinted, embossed or painted upon a manufactured item or object such as an apparel item or a fabric or film substrate.

Returning to FIG. 1, a first example of a UCP (Universal Camouflage Pattern), ACUPAT (Army Combat Uniform PATtern) or “digital camo” 100 is shown to include a first array of light 110, rectangular pixels interspersed with a second array of rectangular pixels which are darker than the light pixels and a third array of rectangular pixels which are darkest 112, and each of these pixels is rendered in a selected standard color or hue selected from standard colors comprising shades of green, brown or blue as used in Mil-Spec standard pixilated UCP camo patterns.

FIG. 2 illustrates a second example UCP or “digital camo” 200 which also includes a first array of light, rectangular pixels interspersed with a second array of rectangular pixels which are darker than the light pixels and a third array of rectangular pixels which are darkest, and each of these pixels is rendered in a selected standard color or hue selected from standard colors comprising shades of green, brown or blue as used in Mil-Spec standard pixilated UCP camo patterns.

FIG. 3 illustrates a first encoded indicia 300 configured and aligned within an area with the exemplary UCP digital camo pattern 100 having a first array of rectangular light portions interspersed with a second array of dark portions which are darker than the encoded indicia's light portions and darker than the camo pattern area's first array of light pixels, in accordance with the present invention. A composite “code in camo” image 400 is generated and then preferably stored as a digital file ready for transmission or imprinted, embossed or painted upon a manufactured item or object such as an apparel item (e.g., a shirt, coat or hat) or a fabric or film substrate.

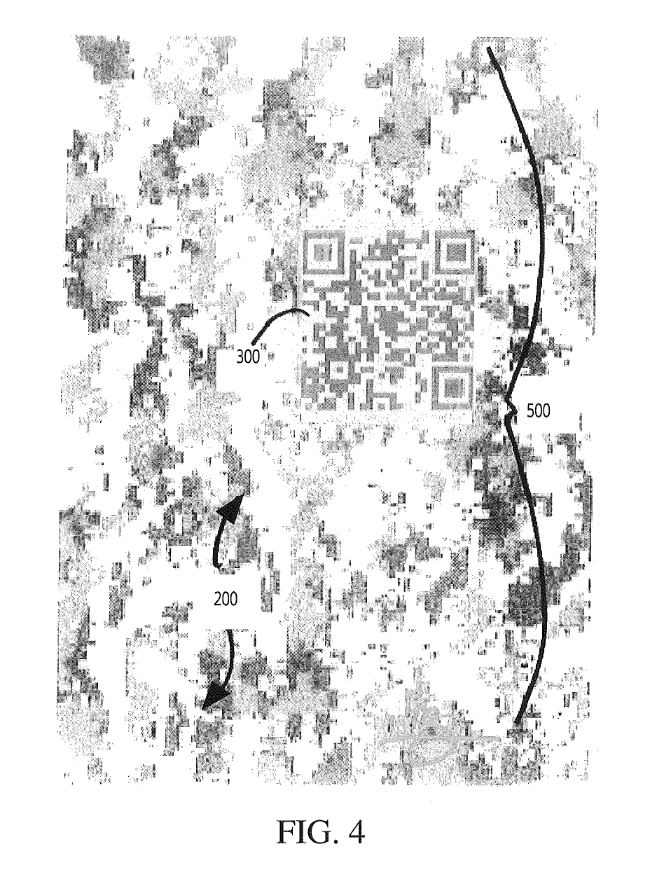

FIG. 4 illustrates encoded indicia 300 configured and aligned within an area with the second exemplary UCP digital camo pattern 200 having a first array of rectangular light portions interspersed with a second array of dark portions which are darker than the encoded indicia's light portions and darker than the camo pattern area's first array of light pixels, in accordance with the present invention. A composite “code in camo” image 500 is generated such that the composite pattern 500 maintains an adequate level of visual crypsis and then preferably stored as a digital file ready for transmission or imprinted, embossed or painted upon a manufactured item or object such as an apparel item (e.g., a shirt, coat or hat) or a fabric or film substrate.

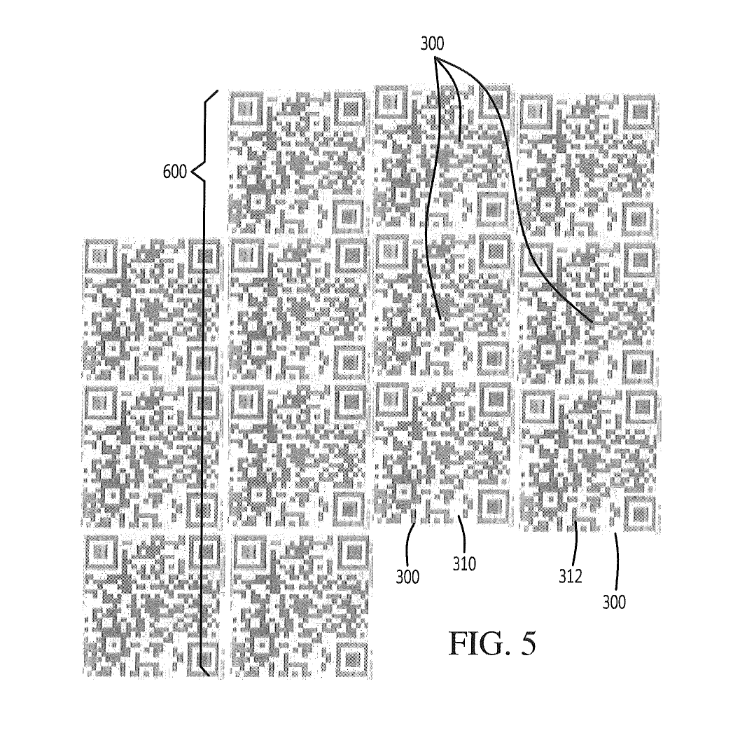

FIG. 5 illustrates a “code only” simulated digital camo pattern 600 comprising only encoded indicia (e.g., multiple copies of QR code pattern 300 or a plurality of distinct code patterns) configured and aligned within an area which could be covered with a typical UCP digital camo pattern (such as 100 or 200) and having a plurality of encoded indicia regions each defining first array of rectangular light portions interspersed with a second array of dark portions which are darker than the encoded indicia's light portions, in accordance with the present invention. A composite “code only” image 600 is generated and then preferably stored as a digital file ready for transmission or imprinted, embossed or painted upon a manufactured item or object such as an apparel item (e.g., a shirt, coat or hat) or a fabric or film substrate. The composite code only image 600 is preferably rendered with a similar contrast ratio to the prior art UCP patterns and in standard UPC camo colors, including shades of green, brown, gray and blue, as often used in the military for selected environments.

Indicia 300 and any of the encoded indicia embodiments are preferably configured for decoding using a standard smart phone, PDA or optical code reader such as an Apple® IPhone® brand smart phone programmed with a Quick Scan™ QR code reading software application.

It will be appreciated by persons having skill in the art that the present invention makes available a system for incorporating manufacturer-selected indicia in a camouflage pattern (e.g., 100 or 200) used on an item which does not ruin the camouflage's effectiveness is programmed to encode a selected indicia such as a manufacturer's brand, an address in a stored Look Up Table or an Internet Uniform Resource Locator used to identify a marked item into a machine readable two-dimensional code pattern such as a QR code pattern 300 having bright portions and dark portions. Two-dimensional code pattern 300 is generated in a selected configuration and orientation with bright code rectangle portions having a first color and dark code rectangle portions having a second color and a specific digital camo pattern (e.g., 100 or 200) having at least a first array of lighter segments in a first selected color interspersed with a second array of darker segments in a second selected color is selected and configured to resemble a pixilated digital camo pattern, and the code pattern's bright portion first color is selected to be substantially the same as the camo pattern's lighter segments and the code pattern's dark portion second color is selected to be substantially the same as the camo pattern's darker segments, as illustrated in FIGS. 3 and 4.

The system preferably includes a memory and generates a composite “code in camo” composite image (e.g., 400 or 500) which is then preferably stored as a digital file in said memory ready for transmission or imprinting upon a manufactured item or object such as an apparel item or a fabric or film substrate. As noted above, in accordance with the present invention, a composite code-in-camouflage pattern (e.g., 400 or 500) is deemed to maintain an adequate level of visual crypsis when the following conditions are satisfied: (a) the overall effect of the code-in-camouflage pattern retains the original camouflage pattern's property of appearing to break-up a surface (when covered by the composite pattern) into a series of apparently unrelated objects, (b) when the lighter portions of the two-dimensional machine readable code segment substantially blend or match the lighter portions of the camouflage pattern, and (c) when the darker portions of the two-dimensional machine readable code segment substantially blend or match the darker portions of the camouflage pattern. For most applications, the when the lighter portions of the two-dimensional machine readable code segment and the lighter portions of the camouflage pattern will not be white, but will instead be grey, tan, green or a light color found in an ambient environment.

A digital camouflage pattern (e.g., 400 or 500) incorporating a machine readable two-dimensional code 300 may be linked to an Internet Uniform Resource Locator, and comprises a digital camouflage pattern incorporating a two-dimensional code such as a QR Code 300 which is readily sensed by an transportable image sensor (e.g., as included in many Smart Phones), stored and then used to find an address in a stored Look Up Table or linked to an on line WWW resource such as a selected Internet Uniform Resource Locator. A camouflaged manufactured item or object such as an apparel item or a fabric or film substrate preferably includes a camouflage pattern covered surface having at least a first array of lighter segments in a first selected color interspersed with a second array of darker segments in a second selected color which are preferably configured to resemble a pixilated digital camo pattern (e.g., 100 or 200) such as the US Army's UCP camo pattern. A selected region of the camouflage pattern surface is imprinted with a contiguous machine readable color-matched two-dimensional code pattern such as a QR code pattern 300 having bright portions and dark portions, where the QR code pattern's bright portions are substantially the same color as the camo pattern's lighter segments and the QR code pattern's dark portions are substantially the same color as the camo pattern's darker segments. The camouflaged manufactured item or object preferably has lighter segments in shades of green, brown or blue selected to resemble standard pixilated digital camo pattern such as the US Military's UCP camo pattern. The darker segments are also preferably in shades of green, brown or blue selected to resemble standard pixilated digital camo pattern such as the US Military's UCP camo pattern.

A manufactured item or object such as an apparel item or a fabric or film substrate made in accordance with the present invention may be configured as shown in FIG. 5 with a selected pattern surface 600 comprised entirely of a plurality of contiguous TR code segments (e.g., 300) having lighter segments in a first selected color interspersed with darker segments in a second selected color, and the first and second colors preferably comprise shades of green, brown or blue selected to resemble standard pixilated digital camo pattern such as the US Army's UCP camo pattern. The QR code patterns in pattern 600 include bright portions and dark portions and the QR code patterns' bright portions provide a camo patterns' lighter segments and the QR code patterns' dark portions provide the camo patterns' darker segments.

The method for encoding indicia and making a digital camouflage pattern incorporating a machine readable two-dimensional code linked to an Internet Uniform Resource Locator shown in FIGS. 3-5 includes the following method steps:

(a) encoding a selected indicia such as a manufacturer's brand, an address in a stored Look Up Table or an Internet Uniform Resource Locator used to identify a marked item into a machine readable two-dimensional code pattern such as a QR code pattern 300 having bright portions and dark portions;

(b) generating the QR code pattern in a selected configuration and orientation with bright portions having a first color and dark portions having a second color;

(c) selecting a specific digital camo pattern (e.g., 100 or 200) having at least a first array of lighter segments in a first selected color interspersed with a second array of darker segments in a second selected color which are preferably configured to resemble a pixilated digital camo pattern such as the US Army's UCP camo pattern;

(d) selecting said QR code pattern's bright portion first color to be substantially the same as the camo pattern's lighter segments;

(e) selecting the QR code pattern's dark portion second color to be substantially the same as the camo pattern's darker segments;

(f) generating a composite “code in camo” image (e.g., 400 or 500) preferably as a digital file ready for transmission or to be imprinted, embossed or painted upon a manufactured item or object such as an apparel item or a fabric or film substrate.

Another method encodes indicia and makes an encoded pattern incorporating a machine readable two-dimensional code linked to an Internet Uniform Resource Locator, comprising an encoded “code-only” pattern by

(a) encoding a selected indicia such as a manufacturer's brand, an address in a stored Look Up Table or an Internet Uniform Resource Locator used to identify a marked item into a first machine readable two-dimensional code pattern such as a QR code pattern (e.g., 300) having bright portions and dark portions;

(b) generating the code pattern in a selected configuration and orientation with bright portions having a first color and dark portions having a second color;

(c) selecting a place for the first code pattern within an array of contiguous code patterns having at least a first array of lighter segments in a first selected color interspersed with a second array of darker segments in a second selected color which are preferably configured to resemble a pixilated digital camo pattern such as the US Army's UDP camo pattern (e.g., 100 or 200);

(d) selecting the QR code pattern's bright portion first color to be substantially the same as a typical camo pattern's lighter segments and selecting the QR code pattern's dark portion second color to be substantially the same as the camo pattern's darker segments and generating the resulting “code-only” pattern surface in colors comprising shades of green, brown or blue selected to resemble standard pixilated digital camo pattern such as the US UCP camo patterns;

(e) generating a composite code-only encoded pattern image 600 by inserting the first QR code pattern within a encoded pattern surface area to create a composite “code-as-camo” image which is then preferably stored as a digital file ready for transmission or imprinted, embossed or painted upon a manufactured item or object such as an apparel item or a fabric or film substrate.

For purposes of nomenclature, the terms “encoded indicia” and “QR code pattern” should be construed to include any machine readable code which can be imprinted or rendered upon a background surface generally in a 2 dimensional pattern having first (e.g., bright) portions which are distinguished from second (e.g., dark) portions.

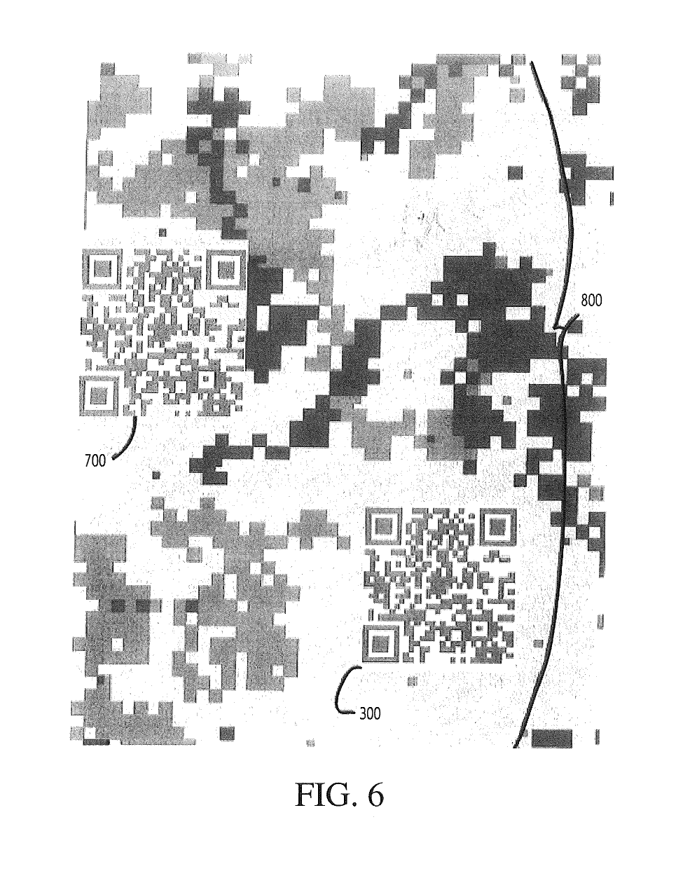

Turning now to the embodiment illustrated in FIG. 6, a selected structure's or object's surface has a background covered with a camo pattern 800 and has a first encoded indicia pattern 300 and a second distinct encoded indicia pattern 700 configured and aligned within an area of digital camo pattern 800, where each of the QR code patterns 300, 700 has a first array of rectangular light portions interspersed with a second array of dark portions which are darker than the encoded indicia's light portions and darker than the camo pattern area's first array of light pixels, in accordance with the present invention. The surface of FIG. 6 can be selected to carry composite camouflage pattern 800 with one or more blended, encoded indicia or QR pattern segments 300, 700, and the method for completing this process includes:

(a) selecting background surface with an outline or shape (e.g., as in FIG. 6) which is selected for visual obfuscation by Crypsis, wherein said selected background surface is selected to (i) bear a general resemblance to an environmental background, (ii) have disruptive patterning (breaking up outline), (iii) eliminate shadow, (iv) provide apparent countershading or (v) provide apparent counter illumination;

(b) encoding a first selected indicia 300 with coded content, said content comprising a context or location sensitive message, a stored Look Up Table address or an Internet Uniform Resource Locator, said encoded indicia comprising a machine readable two-dimensional code pattern such as a QR code pattern 300 having bright portions and dark portions;

(c) generating the QR code pattern 300 in a selected configuration and orientation with bright portions having a first color and dark portions having a second color;

(d) selecting a specific digital camo pattern (e.g., 200 or 800) having at least a first array of lighter segments in a first selected color interspersed with a second array of darker segments in a second selected color which are preferably configured to resemble a pixilated digital camo pattern such as the US Army's UCP camo pattern;

(e) selecting said QR code pattern's bright portion first color to be substantially the same as the camo pattern's lighter segments;

(f) selecting the QR code pattern's dark portion second color to be substantially the same as the camo pattern's darker segments; and

(g) generating a composite “code in camo” image preferably as a digital file ready for transmission or to be imprinted, embossed or painted upon said selected background surface.

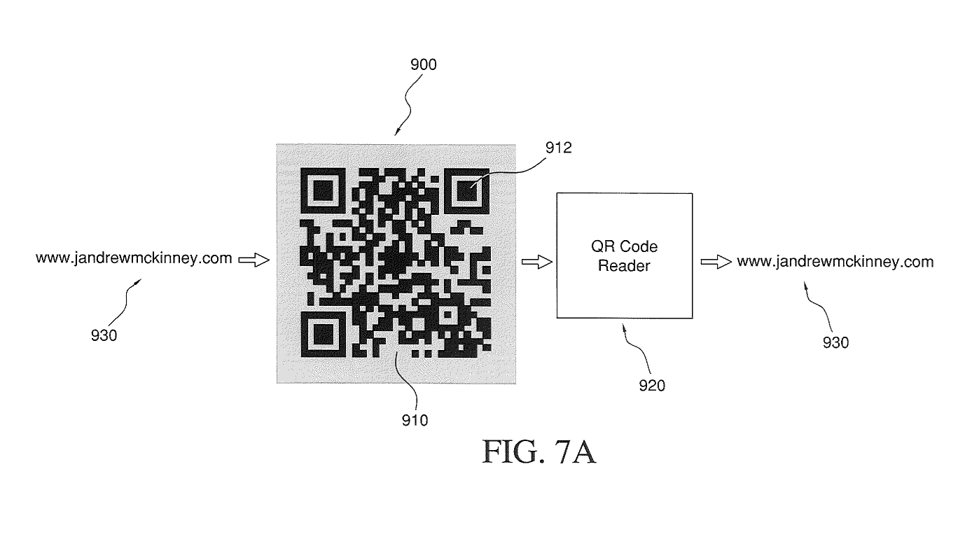

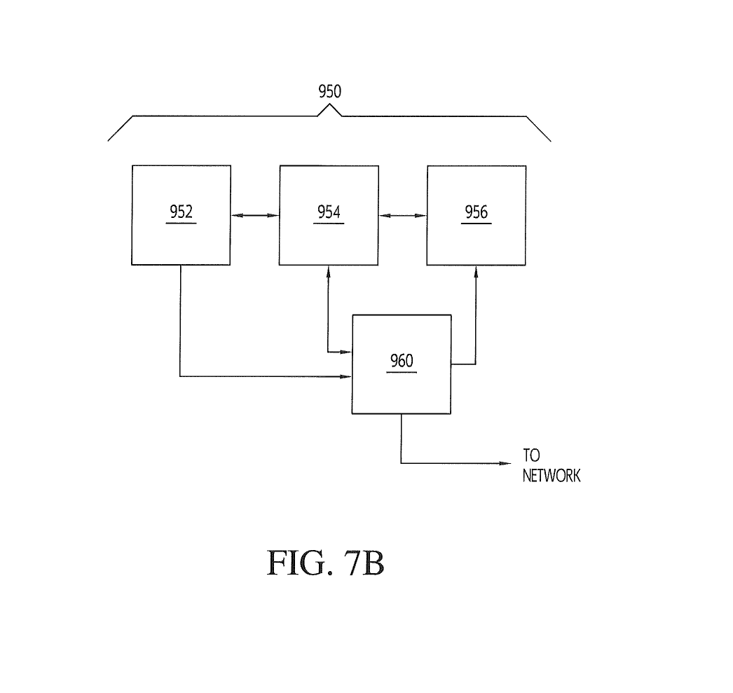

FIG. 7A illustrates, generally, the process of encoding indicia 930 into QR code 900 with bright portions 910 and dark portions 912 and decoding QR code 920 via QR code reader 920 into indicia 930.

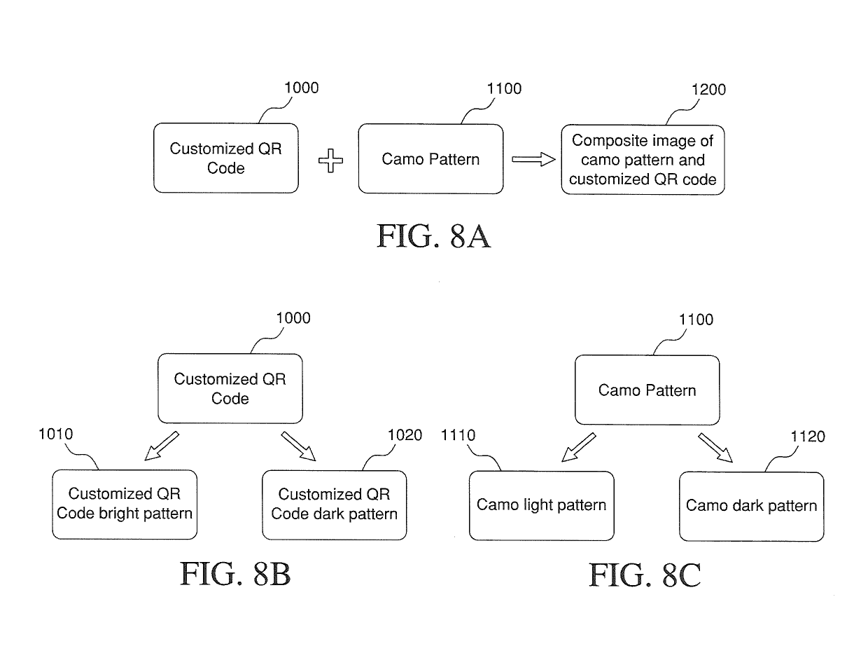

FIG. 8A illustrates the overall process of generating a QR camo code image. The method combines customized QR code 1000 with selected camo pattern 1100 to generate a composite QR camo code image 1200.

FIG. 8B illustrates the components of customized QR code 1000. Customized QR code 1000 is made of customized QR code bright pattern portions 1010 and customized QR code dark pattern portions 1020.

FIG. 8C illustrates the components of selected camo pattern 1100. Camo pattern 1100 is made up of light pattern portions 1110 and dark pattern portions 1120.

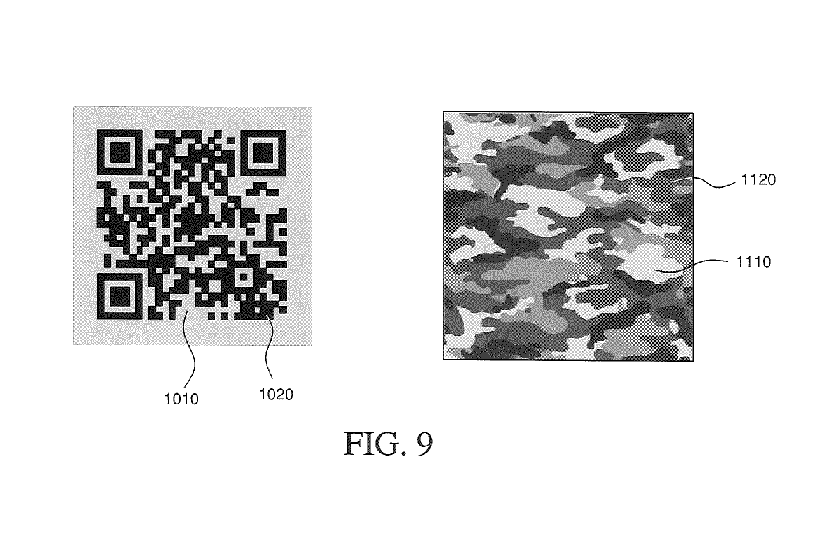

FIG. 9 illustrates the colors of the QR code and camo pattern that are used in generating a QR camo code image. QR code 1000 is made of customized QR code bright pattern portions or first color 1010 and customized QR code dark pattern portions or second color 1020. Camo pattern 1100 is made up of light pattern portions or first selected color 1110 and dark pattern portions or second selected color 1120.

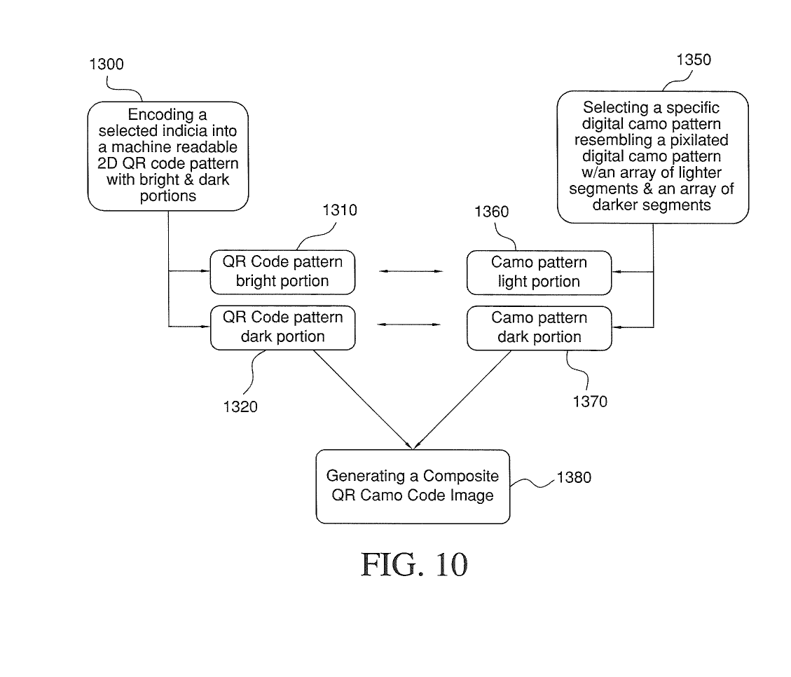

FIG. 10 illustrates an embodiment for incorporating manufacturer-selected indicia in a camouflage pattern used on an item which does not ruin the camouflage's effectiveness, in accordance with the method of the present invention. An indicia is encoded into a QR code 1300 with bright portions 1310 and dark portions 1320. A digital camo pattern is selected 1350 containing an array of light portions 1360 and dark portions 1370. The bright portions of the QR code 1310 are chosen to be substantially similar to the selected camo's light portions 1360. Similarly, the dark portions of the QR code 1320 are chosen to be substantially similar to the selected camo's dark portions 1370. The QR code 1300 and the selected digital camo pattern 1350 are combined to generate a composite QR camo code image 1380.

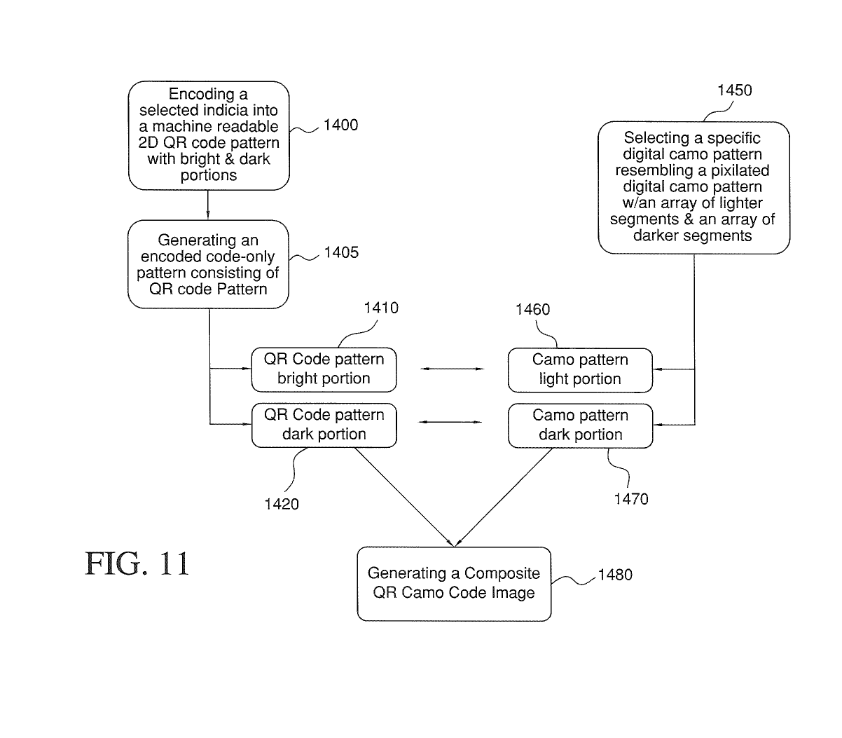

FIG. 11 illustrates another embodiment for incorporating manufacturer-selected indicia in a camouflage pattern used on an item which does not ruin the camouflage's effectiveness using a code-only pattern, in accordance with the method of the present invention. An indicia is encoded into a QR code 1400 with bright portions 1410 and dark portions 1420. A encoded-code only pattern consisting only of the QR code is generated 1405. A digital camo pattern is selected 1450 containing an array of light portions 1460 and dark portions 1470. The bright portions of the QR code 1410 are chosen to be substantially similar to the selected camo's light portions 1460. Similarly, the dark portions of the QR code 1420 are chosen to be substantially similar to the selected camo's dark portions 1470. The QR code pattern 1405 and the selected digital camo pattern 1450 are combined to generate a composite QR camo code image 1480.

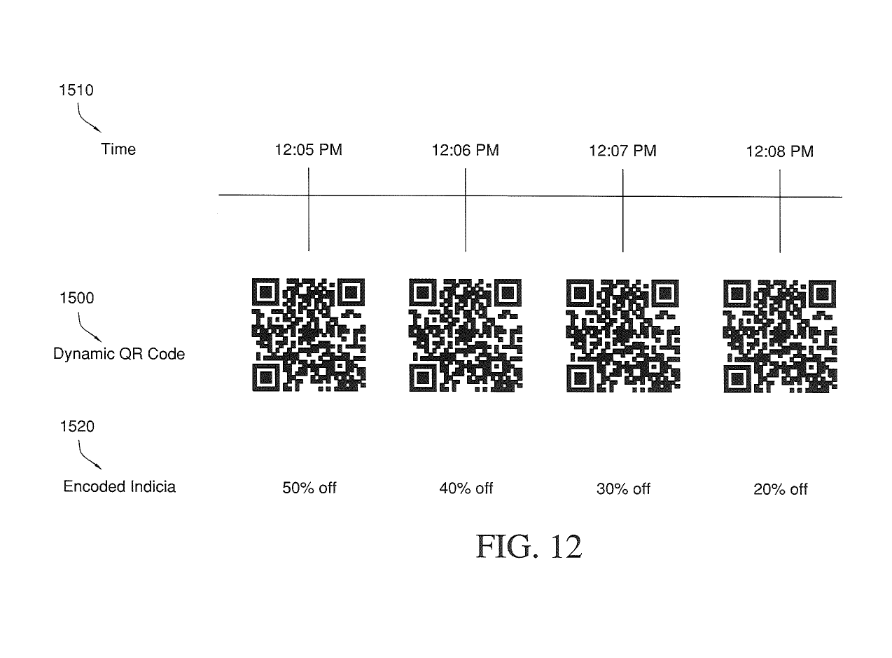

FIG. 12 illustrates a purpose for using a dynamic QR code over time. Over a period of time 1510 a dynamic QR code 1500 may change the indicia encoded 1520 without changing the QR code image itself. The discount or encoded indicia 1520 decreases with each minute that passes by while the dynamic QR code image 1500 itself has not changed.

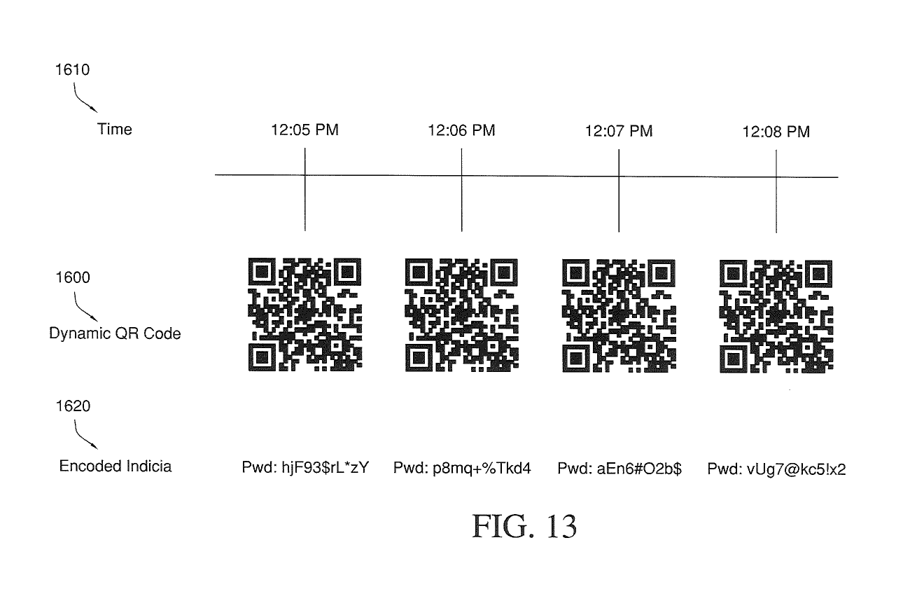

FIG. 13 illustrates another purpose for using a dynamic QR code over time. Over a period of time 1610 a dynamic QR code 1600 may change the indicia encoded 1620 without changing the QR code image itself. The password or encoded indicia 1620 decreases with each minute that passes by while the dynamic QR code image 1600 itself has not changed.

A system for incorporating manufacturer-selected indicia 930 in a camouflage pattern used on an item which does not ruin the camouflage's effectiveness and maintains an adequate level of visual crypsis is programmed to encode a selected indicia such as a manufacturer's brand, an address in a stored Look Up Table or an Internet Uniform Resource Locator used to identify a marked item, into a machine readable two-dimensional code pattern such as a QR code pattern 300 having bright portions 310 and dark portions 312 comprising the two-dimensional code pattern generated in a selected configuration and orientation with bright code rectangle portions having a first color 310 and dark code rectangle portions having a second color 312; and a specific digital camo pattern 100 having at least a first array of lighter segments in a first selected color 110 interspersed with a second array of darker segments in a second selected color 112 is selected and configured to resemble a pixilated digital camo pattern, and the code pattern's bright portion first color is selected to be substantially the same as the camo pattern's lighter segments and the code pattern's dark portion second color is selected to be substantially the same as the camo pattern's darker segments.

A system for incorporating manufacturer-selected indicia 930 in a camouflage pattern used on an item which does not ruin the camouflage's effectiveness is programmed to encode a selected indicia such as a manufacturer's brand, an address in a stored Look Up Table or an Internet Uniform Resource Locator used to identify a marked item, into a machine readable two-dimensional code pattern such as a QR code pattern 1000 having bright portions and dark portions comprising the two-dimensional code pattern generated in a selected configuration and orientation with bright code rectangle portions having a first color 1010 and dark code rectangle portions having a second color 1020; and a specific digital camo pattern 1100 having at least a first array of lighter segments in a first selected color 1110 interspersed with a second array of darker segments in a second selected color 1120 is selected and configured to resemble a pixilated digital camo pattern, and the code pattern's bright portion first color is selected to be substantially the same as the camo pattern's lighter segments and the code pattern's dark portion second color is selected to be substantially the same as the camo pattern's darker segments, where the system includes a memory and generates a composite QR camo code image 1200 and is then stored as a digital file in the memory ready for transmission or imprinting upon a manufactured item or object such as an apparel item or a fabric or film substrate.

A digital camouflage pattern incorporating a machine readable two-dimensional code (e.g. 400, 500) linked to an Internet Uniform Resource Locator, comprising a digital camouflage pattern incorporating a two-dimensional code such as a QR Code, where the pattern can be sensed by a transportable image sensor 920, stored and used to find an address in a stored Look Up Table or linked to an Internet Uniform Resource Locator.

A camouflaged manufactured item or object such as an apparel item or a fabric or film substrate, comprising a camouflage pattern 400 covered surface having at least a first array of lighter segments in a first selected color interspersed with a second array of darker segments in a second selected color which are preferably configured to resemble a pixilated digital camo pattern such as the US Army's UCP camo pattern; a selected region of the camouflage pattern surface imprinted with a contiguous machine readable two-dimensional code pattern such as a QR code pattern 300 having bright portions 310 and dark portions 312, and the QR code pattern's bright portions are substantially the same color as the camo pattern's lighter segments and the QR code pattern's dark portions are substantially the same color as the camo pattern's darker segments.

Additionally, where the lighter segments consist of colors comprising shades of green, brown or blue selected to resemble standard pixilated digital camo pattern such as the US Military's UCP camo pattern.

Also, where the darker segments consist of colors comprising shades of green, brown or blue selected to resemble standard pixilated digital camo pattern such as the US Military's UCP camo pattern.

A manufactured item or object such as an apparel item or a fabric or film substrate, comprising a selected pattern surface 600 comprised entirely of a plurality of contiguous QR code segments 300 having lighter segments in a first selected color interspersed with darker segments in a second selected color; where the first and second colors comprise shades of green, brown or blue selected to resemble standard pixilated digital camo pattern such as the US Army's UCP camo pattern; and where the QR code patterns include bright portions and dark portions and the QR code patterns' bright portions provide a camo patterns' lighter segments and the QR code patterns' dark portions provide the camo patterns' darker segments.

A method for incorporating manufacturer-selected indicia in a camouflage pattern used on an item which does not ruin the camouflage's effectiveness comprising encoding the indicia (e.g. 1300, 1400), where the indicia is a manufacturer's brand, an address in a stored look up table or an internet uniform resource locator and where the indicia is used to identify a marked item, into a machine readable two-dimensional code pattern, where the pattern is a QR code pattern consisting of a first color (e.g. 1310, 1410) and a second color (e.g. 1320, 1420) where the first color is brighter than the second color; selecting a digital camo pattern consisting of a first array of lighter segments in a first selected color (e.g. 1360, 1460) interspersed with a second array of darker segments in a second selected color (e.g. 1370, 1470) where the first selected color is brighter than the second selected color and the first array of lighter segments and the second array of darker segments are configured to resemble a pixelated digital camo pattern similar to the US Army's UCP camo pattern; selecting the first color of the QR code pattern to be substantially similar to the first selected color segment of the first array of lighter segments; selected the second color of the QR code pattern to be substantially similar to the second selected color segment of the second array of darker segments; generating a composite QR camo code image (e.g. 1380, 1480), where the generating consists of placing the QR code pattern within the digital camo pattern and where the QR camo code is a digital file ready for transmission or to be imprinted, embossed, or painted upon a manufactured item or object such as an apparel item or a fabric or film substrate.

A method for incorporating manufacturer-selected indicia in a camouflage pattern used on an item which does not ruin the camouflage's effectiveness comprising encoding the indicia, where the indicia is a manufacturer's brand, an address in a stored look up table or an internet uniform resource locator and where the indicia is used to identify a marked item, into a machine readable two-dimensional code pattern 300, where the pattern is a QR code pattern consisting of a first color 310 and a second color 312 where the first color is brighter than the second color; generating an encoded code-only pattern (e.g. 600, 1405) consisting of the QR code patterns 300; selecting a place for the first code-only pattern within an array of contiguous QR code patterns having at least a first array of lighter segments in a first selected color 1410 interspersed with a second array of darker segments in a second selected color 1420 wherein the first selected color is brighter than the second selected color and configured to resemble a pixelated digital camo pattern similar to the US Army's UCP camo pattern; selecting the first color of the QR code pattern to be substantially similar to a typical camo pattern's lighter segments 1460 and selecting the second color of the QR code pattern to be substantially similar to a typical camo pattern's darker segments 1470; generate the code-only pattern, where the first selected color and the second selected color comprise shades of green, brown, or blue and are selected to resemble a pixelated digital camo pattern similar to the US Army's UCP camo pattern; generating a composite encoded code-only pattern QR camo code image where the generating consists of inserting the first QR code pattern within a code-only pattern surface area, and where the QR camo code is a digital file ready for transmission or to be imprinted, embossed, or painted upon a manufactured item or object such as an apparel item or a fabric or film substrate.

A method for encoding and using a camouflage pattern with a blended, encoded indicia 300, comprising selecting a background surface with an outline or shape which is selected for visual obfuscation by Crypsis 100, wherein the selected background surface is selected to bear a general resemblance to an environmental background, have disruptive patterning (breaking up outline), eliminate shadow, provide apparent countershading, or provide apparent counter illumination; encoding the indicia with coded content, wherein the content comprises a context or location sensitive message, a stored Look Up Table address or an Internet Uniform Resource Locator, into a machine readable two-dimensional code pattern such as a QR code pattern consisting of a first color 310 and a second color 312 where the first color is brighter than the second color; selecting a digital camo pattern 100 consisting of a first array of lighter segments in a first selected color interspersed with a second array of darker segments in a second selected color wherein the first selected color is brighter than the second selected color and the first array of lighter segments and the second array of darker segments are configured to resemble a is pixelated digital camo pattern similar to the US Army's UCP camo pattern; selecting the first color of the QR code pattern to be substantially similar to the first selected color segment of the first array of lighter segments; selected the second color of the QR code pattern to be substantially similar to the second selected color segment of the second array of darker segments; generating a composite QR camo code image 400, where the generating consists of placing the QR code pattern within the digital camo pattern and where the QR camo code is a digital file ready for transmission or to be imprinted, embossed, or painted upon the selected background surface.

A camouflage graphic image featuring manufacturer-selected indicia 300 encoded within a composite pattern includes a digital camouflage pattern incorporating a two-dimensional code such as a QR Code 300, where the pattern can be read by a transportable image sensor 920, stored and used to decode the indicia.

The composite pattern (e.g. 400, 500) maintains an adequate level of visual crypsis and is optionally imprinted upon or incorporated onto a surface of a flexible substrate for making garments, covers or “wraps” adapted for use as an adhesive covering.

The unencoded user or manufacturer-selected indicia 930 may be a manufacturer's brand, an address in a stored look up table or an internet uniform resource locator, where the indicia is used to identify a marked item, and this indicia is encoded to generate a machine readable two-dimensional code pattern 900.

The system for incorporating user or manufacturer-selected indicia 930 may be configured to generate an encoded indicia configured for use with a selected camouflage pattern used on an item which does not reduce the camouflage's effectiveness comprising: (a) a two-dimensional code pattern 1000 generated in a selected configuration and orientation with bright code rectangle portions having a first color 1010 and dark code rectangle portions having a second color 1020, where the manufacturer-selected indicia is a manufacturer's brand, an address in a stored look up table or an internet uniform resource locator and where the indicia is used to identify a marked item; and (b) a specific digital camouflage pattern 1100 having at least a first array of lighter segments in a first selected color 1110 interspersed with a second array of darker segments in a second selected color 1120 is selected and configured to resemble a pixilated digital camouflage pattern, and the code pattern's bright portion first color is selected to be substantially the same as the camouflage pattern's lighter segments and the code pattern's dark portion second color is selected to be substantially the same as the camouflage pattern's darker segments.

Turning now to FIG. 7B, the encoded camouflage pattern generating system 950 preferably includes a camo image generator 952 programmed to retrieve selected camo pattern data files from a memory 954 and a QR code generator 956 is also programmed to retrieve selected 2-D indicia encoding data from system memory 954 and all are preferably configured to work with controller 960 which is configured to receive and transmit data over a digital communications network. In operation, encoded camouflage pattern generating system 950 generates a composite QR camouflage code image (e.g., 300 or 400) which is then stored as a composite digital image file in system memory 954 ready for transmission or imprinting upon a manufactured item or object such as an apparel item or a fabric or flexible substrate. Camo image generator is preferably programmed to generate standard (e.g., digital) camo patterns in user-selected colors controlled via a user accessible website.

In accordance with the method of the present invention, a user employs encoded camouflage pattern generating system 950 for incorporating manufacturer-selected indicia in a camouflage pattern used on an item (e.g., a hat, not shown) in a manner which does not ruin the camouflage's effectiveness, so that the composite code and camo pattern (e.g., 300 or 400) maintains an adequate level of visual crypsis. The method has specific steps, including: (a) encoding the indicia, (e.g., a manufacturer's brand, an address in a stored look up table or an internet uniform resource locator, or “URL”), into a machine readable two-dimensional code pattern. And the two-dimensional code pattern is preferably a QR code pattern (e.g. 1300, 1400) consisting of a first color (e.g. 1310, 1410) and a second color (e.g. 1320, 1420) where the first color is brighter than the second color. The next step is (b) selecting a digital camouflage pattern (e.g. 1350, 1450) consisting of a first array of lighter segments in a first selected color (e.g. 1360, 1460) interspersed with a second array of darker segments in a second selected color (e.g. 1370, 1470) where the first selected color is brighter than the second selected color. The next step is (c) selecting the first color of the QR code pattern (e.g. 1310, 1410) to be substantially similar to the first selected color segment of the first array of lighter segments (e.g. 1360, 1460), and then the next step is (d) selecting the second color of the QR code pattern (e.g. 1320, 1420) to be substantially similar to the second selected color segment of the second array of darker segments (e.g. 1370, 1470). Next, the system is programmed to (e) generate a composite QR camouflage code image (e.g. 1380, 1480), where the generating consists of placing the QR code pattern within the digital camouflage pattern to generate a composite code-camo pattern (e.g., 300 or 400), where the composite QR camouflage code pattern is preferably stored as a digital file ready for transmission or to be imprinted, embossed, or painted upon a manufactured item or object such as an apparel item or a fabric or film substrate.

Optionally, the composite QR code pattern can comprise an array of contiguous QR code patterns 1405 having at least a first array of lighter segments in a first selected color interspersed with a second array of darker segments in a second selected color where the first selected color is brighter than the second selected color and configured to resemble a pixelated digital camo pattern. Preferably, the method also includes printing the digital file on a fabric or flexible substrate.

Persons having skill in the art will appreciate that the present invention makes available a camouflage graphic (e.g., as shown in FIGS. 3 and 4) including a substantially concealed machine readable coded indicia (e.g., 300) for which a composite code-in-camouflage pattern (e.g., 400) includes a digital camouflage pattern segment (e.g., 100 or 200) and a two-dimensional machine readable code segment (e.g., 300). Where the machine readable code segment (e.g., 300) is readable by a transportable image sensor (or Smart Phone), and where the composite code-in-camouflage pattern (e.g., 400 or 500) maintains an adequate level of visual crypsis.

As noted above, a composite code-in-camouflage pattern (e.g., 400 or 500) is deemed to maintain an adequate level of visual crypsis when the following conditions are satisfied: (a) the overall effect of the code-in-camouflage pattern retains the original camouflage pattern's property of appearing to break-up a surface (when covered by the composite pattern) into a series of apparently unrelated objects, (b) when the lighter portions of the two-dimensional machine readable code segment substantially blend or match the lighter portions of the camouflage pattern, and (c) when the darker portions of the two-dimensional machine readable code segment substantially blend or match the darker portions of the camouflage pattern. For most applications, the when the lighter portions of the two-dimensional machine readable code segment and the lighter portions of the camouflage pattern will not be white, but will instead be grey, tan, green or a light color found in an ambient environment.

The system and method of the present invention are well suited for making camouflaged segments of substrate surface (e.g., a fabric or flexible substrate surface resembling the surfaces shown in FIGS. 3 and 4), where a user-selected camouflage pattern covers a surface having at least a first array of lighter segments in a first user-selected color (preferably not white) interspersed with a second array of darker segments in a second selected color which are configured to resemble a user-selected pixilated digital camouflage pattern. A selected region of the camouflage pattern surface is imprinted with a machine readable two-dimensional code pattern (e.g., 300) having bright portions and dark portions, and the two-dimensional code pattern's bright portions are substantially the same color as the digital camouflage pattern's lighter segments and the two-dimensional code pattern's dark portions are substantially the same color as the digital camouflage pattern's darker segments.

The method for concealing user-selected indicia in a camouflage pattern of the present invention (as illustrated in FIGS. 8A-8C and FIGS. 10-13 does not ruin the camouflage's effectiveness and maintains an adequate level of visual crypsis principally because the user selected indicia is encoded into a machine readable two-dimensional code pattern having regions with a selected first color (preferably not white) interspersed with regions of a second color where the first color is lighter or brighter than the second color, and the user also selects a digital camouflage pattern (e.g., 100 or 200) consisting of a first array of lighter segments in a first selected color interspersed with a second array of darker segments in a second selected color, where the camo pattern's first selected color (preferably not white) is brighter than the second selected color. As noted above, the first color of the machine readable two-dimensional (e.g., QR) code pattern (e.g., 300) must be substantially similar to or blend with the camouflage pattern's lighter segments, and the second color of the machine readable two-dimensional code pattern must be substantially similar to or blend with the camouflage pattern's darker segments. Once these conditions are met, the system 950 is programmed to generate a composite code-in-camouflage image (e.g., 400 or 500).

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as set forth in the appended claims.

What is claimed is:

1) A camouflage graphic including machine readable coded indicia, comprising:
a composite code-in-camouflage pattern comprising a digital camouflage pattern segment and a two-dimensional machine readable code segment, wherein said machine readable code segment is readable by a transportable image sensor, and wherein said composite code-in-camouflage pattern maintains an adequate level of visual crypsis.

2) The camouflage graphic of claim 1, wherein said code-in-camouflage pattern's two-dimensional machine readable code segment comprises a QR code segment.

3) The camouflage graphic of claim 1, wherein said manufacturer-selected indicia comprises an internet uniform resource locator address.

4) The camouflage graphic of claim 1, wherein said two-dimensional machine readable code segment comprises information used to identify a marked item.

5) A camouflaged segment of substrate surface, comprising:
(a) a camouflage pattern covered surface having at least a first array of lighter segments in a first selected color interspersed with a second array of darker segments in a second selected color which are configured to resemble a pixilated digital camouflage pattern;
(b) a selected region of the camouflage pattern surface imprinted with a contiguous machine readable two-dimensional code pattern having bright portions and dark portions;
(c) wherein the two-dimensional code pattern's bright portions are substantially the same color as the digital camouflage pattern's lighter segments and the two-dimensional code pattern's dark portions are substantially the same color as the digital camouflage pattern's darker segments.

6) The camouflaged substrate segment of claim 5, wherein said machine readable two-dimensional code pattern comprises a QR code pattern, and wherein the QR code pattern's bright portions are substantially the same color as the digital camouflage pattern's lighter segments and the QR code pattern's dark portions are substantially the same color as the digital camouflage pattern's darker segments.

7) A method for concealing user-selected indicia in a camouflage pattern which does not ruin the camouflage's effectiveness and maintains an adequate level of visual crypsis, comprising:
(a) encoding the user selected indicia into a machine readable two-dimensional code pattern having regions with a first color interspersed with regions of a second color wherein said first color is brighter than said second color;
(b) selecting a digital camouflage pattern consisting of a first array of lighter segments in a first selected color interspersed with a second array of darker segments in a second selected color, wherein said first selected color is brighter than said second selected color;
(c) selecting said first color of said machine readable two-dimensional code pattern to be substantially similar to said camouflage pattern's first selected color segment of said first array of lighter segments;
(d) selecting said second color of said machine readable two-dimensional code pattern to be substantially similar to said camouflage pattern's second selected color segment of said second array of darker segments; and
(e) generating a composite code-in-camouflage image.

8) The method of claim 7, wherein said machine readable two-dimensional code consists of a QR code and step (e) comprises placing a QR code pattern within said digital camouflage pattern and wherein said code-in camouflage image comprises a QR camouflage composite stored as a digital file ready for transmission or to be imprinted upon a manufactured item or object such as a fabric or film substrate.

9) The method of claim 7, wherein said QR code pattern comprises an array of contiguous QR code patterns having at least a first array of lighter segments in a first selected color interspersed with a second array of darker segments in a second selected color and wherein said first selected color is brighter than said second selected color and configured to resemble a pixelated digital camo pattern which maintains an adequate level of visual crypsis.

10) The method of claim 7 further comprising: printing said digital file on a fabric or flexible substrate.
